(19) United States
(12) Patent Application Publication
(10) Pub. No.: US 2011/0030361 A1
(43) Pub. Date: Feb. 10, 2011

(54) HYDROSTATIC LINEAR WIND MILL FOR WIND ENERGY HARNESSING APPLICATIONS

(75) Inventors: Swaminathan Gopalswamy, Novi, MI (US); Sundaresan A. Sorakayalpet, Chennai (IN)

Correspondence Address: MILLER, CANFIELD, PADDOCK AND STONE, 277 SOUTH ROSE STREET, SUITE 5000, KALAMAZOO, MI, 49007, US

(73) Assignee: NewWindTech LLC, Canton, MI (US)

(21) Appl. No.: 12/851,802

(22) Filed: Aug. 6, 2010

Related U.S. Application Data
(60) Provisional application No. 61/231,856, filed on Aug. 6, 2009.

(51) Int. Cl. F16D 31/02

(52) U.S. Cl. 60/398

(57) ABSTRACT

A linearly translating set of aerofoil blades guided along rigid supporting columns that build up hydraulic energy by drawing hydraulic working liquid from a low pressure reservoir and pushing it into a high pressure accumulator through pistons and hydraulic cylinders. The functioning of an intelligent controller senses the motion of the aerofoil blades and controls orientation with respect to the wind and the valves in the hydraulic circuit so that the aerofoil blades, irrespective of their forward or return motion, always draw liquid from the low pressure reservoir and push it into the high pressure accumulator is also described.

### CROSS REFERENCE TO RELATED APPLICATION DATA

The disclosure claims priority to U.S. Provisional Patent Application No. 61/231,856, filed Aug. 6, 2009, and a PCT Application is concurrently filed.

### BACKGROUND

The present disclosure is in the technical field of efficient harnessing of wind power. More particularly, the present disclosure is in the field of aerofoil blades that translate linearly along guided rails converting wind energy into pressurized hydraulic working fluid that can be used for either generating electrical energy or producing mechanical power.

Wind power can be captured by placing blades in the path of the wind. These blades typically have an “aerofoil” shaped cross-section as shown in FIG. 1. An aerofoil placed in wind, experiences lift force (force perpendicular to the direction of wind) and drag force (force parallel to the direction of wind). By letting the lift force push the blade, the blade moves, and wind power can be harnessed.

By making these blades attached to a rotatable shaft in wind turbines, rotary motion is achieved, enabling continuous harnessing of wind power. This is the traditional method of harnessing wind power. Typically, this rotary motion is used to power an electric generator and generate electric power.

While modern turbines have become relatively efficient, they pose some significant challenges: high cost, wind noise, safety, manufacturing, transportation and installation difficulties, and limited range of wind speeds at optimal power generation.

Instead of attaching the aerofoil to a rotating shaft, attempts have been made instead to capture the wind power through linear motion. These have in general been complex mechanisms that are expensive to make and fraught with safety and reliability issues.

### PRIOR ART

Wind power harnessing using rotational devices is very common and is not discussed in this disclosure. This disclosure focuses on prior art related to using linear motion for generating power and/or use of pressurized hydraulic systems as part of the harnessing technology.

U.S. Pat. No. 6,523,781 entitled “Axial-mode linear wind-turbine” discloses:
A wind harnessing system using a plurality of self supporting airfoil kites 50 for production of useful power. The system comprising multiple airfoil kites 50 in tandem attached to a pivotal control housing 32 by control lines 58L and 58R and support lines 60L and 60R. Control lines 58L and 58R can change length with respect to the length of support lines 60L and 60R to control the airfoil kites' 50 angle-of-attack, pitch angle, direction of flight, and flight speed. The length of control lines 58L and 58R are controlled from ground station 30 by a movable pulley system in control housing 32 to adjust the airfoils' direction to follow a specific flight path 140. Control lines 58R and 58L and support lines 60R and 60L are also wound on a power shaft and pulley system in control housing 32. As the airfoil kites are propelled by the wind at very-high speed, the airfoils generate a powerful axial force. The control lines 58L and 58R and support lines 60L and 60R are then reeled-out under this axial tension causing the power shaft and pulley system in control housing 32 to turn a generator to generate electricity. After airfoil kites 50 have finished their reel-out power stroke 140a, the airfoil's pitch angle is made negative so they can be reeled-in by their control and support lines using a minimum of force along path 140b. Once the airfoils have been rewound to the proper distance, the airfoils are again angled for high-speed operation to generate powerful axial force and reeled-out along 140c to provide another power stroke. The airfoil kites are then reeled-in again along path 140d and the entire process repeats starting with power stroke 140a. Since the force to rewind the airfoils is much less than the force generated during reel-out, there is net power generated.

U.S. Pat. No. 7,275,719 entitled “Wind drive apparatus for an aerial wind power generation system” discloses:
Wind driven apparatus for an aerial power generation system include driven elements and controls. The driven elements are configured and shaped to provide maximum force from both lift and drag during the downwind phase of operation and minimum force during the upwind phase. The driven elements have a sail portion with a leading edge and a trailing edge. The controls change the driven elements between high force configurations for downwind operation and low force configurations for upwind operation, adjust the pitch and azimuth angles of the driven elements, and control the camber.

U.S. Pat. No. 7,504,741 entitled “Wind energy plant with a steerable kite” discloses:
A device for converting wind flow energy into mechanical energy comprising a wind-engaging member having an aerodynamic profile which generates an uplift force in the direction of a load cable when the airflow direction is perpendicular to the load cable, a steering mechanism configured to produce a steered movement about a first axis or in a first direction of the wind-engaging member and about a second axis or in a second direction that is different from the first direction or axis of the wind-engaging member, relative to the airflow direction, and a control unit configured to use the steering mechanism to move the wind-engaging member along a predetermined flight path in a flight plane perpendicular to the load cable. The patent further provides a method for converting wind flow energy into mechanical energy and a docking station for use with the device.

U.S. Pat. No. 6,555,931 entitled “Renewable energy systems using long-stroke open-channel reciprocating engines” discloses:
Renewable energy systems extracting energy from natural water flow or wind. The energy systems are configurations of long-stroke open-channel reciprocating engines employing one or two flow engaging elements such as drogue chutes for water flow or airfoils for wind applications tethered to a power drum and useful to generate electricity or to pump water as from wells. A wind energy system using two buoyant airfoils emblazoned with advertising messages is suitable for urban deployment generating electric power and also supporting an advertising revenue stream.

U.S. Pat. No. 7,418,820 entitled “Wind turbine with hydraulic transmission” discloses:
A wind turbine includes a closed loop hydrostatic transmission. The rotor is directly coupled to a low-speed high torque hydraulic motor, which is pressure-reversible to act as a pump. A variable displacement, pressure compensated hydrostatic transmission receives the hydraulic fluid output and drives a generator. The hydrostatic transmission and the generator may be compactly located in the nacelle of wind turbine tower.

U.S. Patent publication number 2005/0155346 entitled “Wind power machine” discloses:
A wind power machine for production of energy comprises at least one rotor element (5) which can be driven by the wind and having an output load (15), in particular a generator (16), which is connected directly or indirectly to it, the rotor element (5) is intended to drive one or more hydraulic pumps (7) directly or indirectly.

### SHORTCOMINGS OF PRIOR ART

This prior-art can be classified into two major categories:

those that use linear motion of the aerofoil blades or kites to generate rotary motion

those that use rotary motion of a wind turbine to drive a hydraulic pump.

A problem with the first category is that all the systems proposed involve relatively high-altitude flying aerofoil kites. To avoid these kites getting entangled with neighboring structures, they will need to be reeled in whenever there is no wind. Since these kites are controlled through multiple supporting lines or wires, there is a high probability of these lines getting twisted and tangled with each other whenever there is turbulence in the wind and the kite twists about itself. The linear motion of the kites is converted to rotary motion either through reciprocating mechanism or through pulleys. The mechanical power available in the form of rotary motion suffers from additional disadvantages that it has to be immediately consumed, it is inherently non-uniform and it can not adjust itself to the actual demand.

A problem with the second category is associated with the transportation, erection and maintenance of the large wind turbines. A hydraulic pump needs to be placed at a high level making installation and maintenance difficult. The wind turbine by design is optimal only over a specific range of wind speeds.

The device described in this document was designed specifically to address these limitations in prior art.

### SOME NOTES ON PRIOR ART

In most arrangements, the aerofoil kites are freer to move around—they are loosely controlled through wires.

The linear motion of the aerofoil kites is converted to rotational motion through pulleys or through a reciprocating mechanism.

Hydraulic transmission is used only in cases where the wind energy is directly converted to rotational motion as through a wind turbine.

Wind turbine blades need to be designed to withstand the large centrifugal forces they withstand. Hence they need to be manufactured as one single piece—they can not be assembled from parts in the field. Transporting and erecting large blades poses many problems and challenges.

The hydraulic pressure is built up using rotational machinery such as a hydraulic pump.

In summary: Certain aspects of the disclosed system (linear motion, hydraulic transmission, etc) are disclosed, but no patent includes an entire solution similar to implementation of this disclosure (aerofoil translating along rigid supports and driving hydraulic pistons to build up pressure in an accumulator).

Further, U.S. Publication 2007/0040389 entitled “Adaptable Flow-Driven Energy Capture System” discloses:
A scalable fluid-driven assembly that is configured to oscillate in the presence of fluid-flow. The assembly includes an adjustable electromechanically controlled fluidfoil. The fluidfoil is controlled to permit a consistently optimum angle of attack into the prevailing flow and to remain parallel with respect thereto.

While the Kelley publication discloses a use of foils in a reciprocating motion (as against rotary motion in regular turbines), the mechanization is different, and there is no disclosure of a control mechanism or the translation of the mechanical energy from the blades to electrical (or hydraulic) power.

This disclosure discusses a methodology and mechanism to harness wind power that would attempt to overcome some of the challenges. Specifically, this disclosure leverages the idea of a reciprocating aerofoil, a reciprocating hydraulic piston and cylinder arrangement, and a pressurized hydraulic accumulator leading to a novel arrangement for harnessing wind power.

### BRIEF SUMMARY

The present disclosure consists of one or more linearly translating aerofoil blades in a direction perpendicular to that of the wind, driving one or more hydraulic pistons, building up hydraulic pressure through the use of a hydraulic circuit in which a hydraulic working liquid flows from a low pressure reservoir into a high pressure accumulator. Energy stored as hydraulic pressure in the high pressure accumulator can be extracted as and when desired and converted into mechanical energy through a hydraulic motor. This eventually can further be converted to electrical energy using an electric generator.

The linearly translating set of aerofoil blades can be guided along rigid supporting columns that build up hydraulic energy by pushing hydraulic working liquid into a high pressure accumulator through pistons and hydraulic cylinders. An intelligent controller can sense the motion of the aerofoil blades and can control orientation with respect to the wind and the valves in the hydraulic circuit so that the aerofoil blades, irrespective of their forward or return motion, always draw liquid from the low pressure reservoir and push it into the high pressure accumulator.

A device for harnessing wind power using linear motion may include:

a plurality of parallel reciprocating aerofoil blades that translate linearly in synchronization, converting wind energy into pressurized hydraulic working fluid that can be used for generating electrical energy or producing mechanical power;

a reciprocating piston and hydraulic cylinder arrangement; wherein the aerofoil blades can be pivotably connected to a linkage that drives the reciprocating piston inside the hydraulic cylinder;

a hydraulic high pressure accumulator that stores hydraulic energy from the hydraulic working liquid being pushed into the high pressure accumulator; and

a hydraulic control mechanism to ensure that the pressurized hydraulic working fluid is directed to a correct side of the hydraulic cylinder with respect to the piston,

wherein the aerofoil blades drive the piston to build up hydraulic pressure in the accumulator through the piston and hydraulic cylinder arrangement.

### BRIEF DESCRIPTION OF THE DRAWINGS

The above mentioned and other features of this disclosure and the manner of obtaining them will become more apparent, and the disclosure itself will be best understood by reference to the following description of the devices and processes taken in conjunction with the accompanying figures, which are given as non-limiting examples only, in which:

FIG. 1 explains an underlying concept of the device;

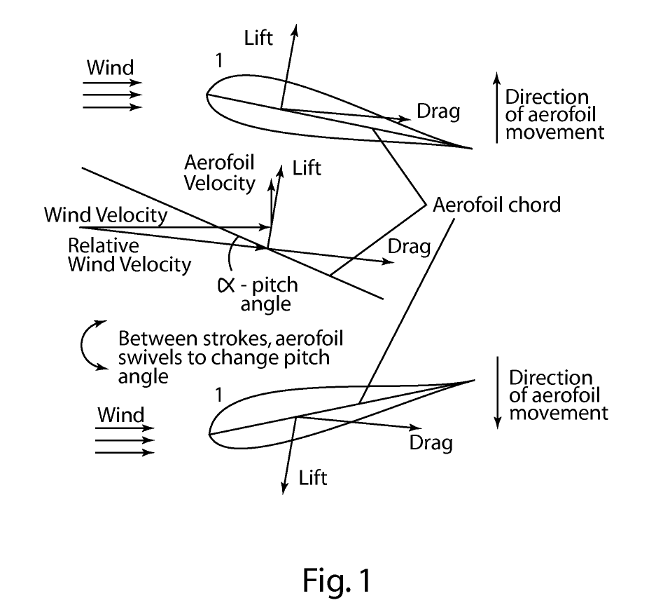

FIG. 2 is a schematic of the basic concept;

FIG. 3 is a schematic showing multiple aerofoil blades;

FIG. 4 is a schematic showing energy conversion through a hydraulic circuit and use of two-way valves;

FIG. 5 is a schematic of the overall linear wind turbine;

FIG. 6 shows linear wind turbine with finer pressure control;

FIG. 7 shows a schematic of a pressure transformer;

FIG. 8 shows a control diagram;

FIG. 9 shows multiple linear wind turbines combined in a wind farm;

FIG. 10 shows possible layouts for aerofoil blades, shown as blade sections;

FIG. 11 illustrates realization of a multiple three-blade linear wind turbine; and

FIG. 12 shows a guidance system for a multiple three-blade linear wind turbine.

The exemplifications set out herein illustrate embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiment in different forms, the figures show, and herein described in detail, embodiments with the understanding that the present descriptions are to be considered exemplifications of the principles of the disclosure and are not intended to be exhaustive or to limit the disclosure to the details of construction and the arrangements of components set forth in the following description or illustrated in the figures.

This disclosure includes a new way to harness wind energy, convert into another form and store it so that can be used as and when required.

### Fundamental Concept:

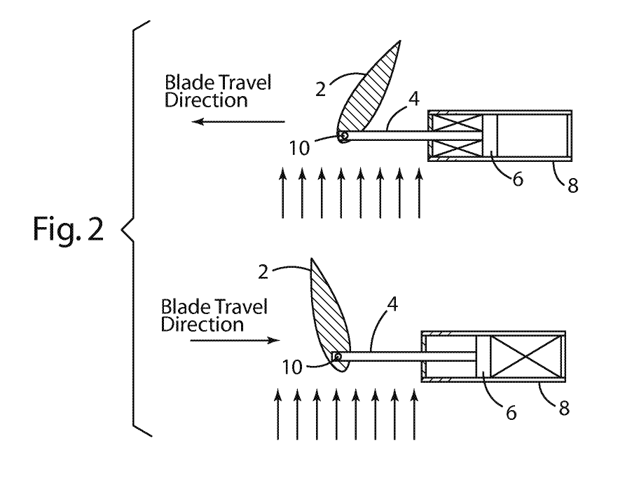

The fundamental concept is a novel integration of the following ideas: (i) combining the linear motion of an aerofoil 2 directly with a reciprocating hydraulic piston and cylinder arrangement as shown in FIG. 2, and (ii) storing the hydraulic energy in hydraulic accumulators to enable power extraction independent of power harnessing.

As shown in FIG. 2, a cross sectional view of an aerofoil 2 is shown placed in the path of the wind. The aerofoil 2 is connected to linkage 4 via a pivotable hinge joint 10. Linkage 4 is in turn connected to a piston 6 that moves inside a cylinder 8. Depending on the orientation of the aerofoil 2 with respect to the wind, different lift forces are generated on the aerofoil 2. During the forward stroke, the forces tend to move the aerofoil 2 to the right as shown in the figure, and in the reverse stroke, the forces will move the aerofoil 2 to the left. These forces are used to pressurize a fluid within the cylinder 8 (marked by the shaded region within the cylinder 8).

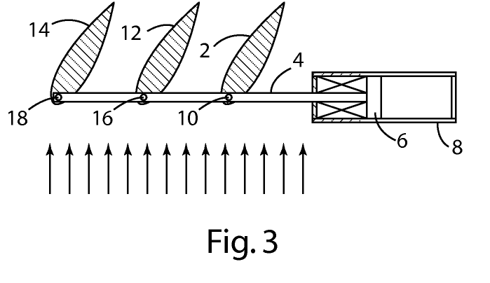

Considering the swept area of a blade formed from an aerofoil 2, the overall efficiency of power extraction can increase by adding additional blades moving parallel to each other in synchronization. FIG. 3 illustrates the concept with three blades 2 (aerofoil), 12 and 14 moving in synchronized fashion.

As shown in FIG. 3, the blades 2 (aerofoil), 12 and 14 in the example can move in synchronization with each other and are connected to the piston 6 inside cylinder 8 via a linkage 4, such as a common connecting rod. By carefully optimizing the number of blades per unit length, one can achieve close to the Betz limit on power capture efficiency.

The power extracted from the aerofoil 2 depends on the speed of the blade, the wind speed, and the orientation of the aerofoil chord with respect to the wind speed. The mechanism to adjust orientation of the aerofoil 2 with respect to the wind is called “pitch control.” Pitch control can be used to (i) reverse the direction of the lift force at the end of the forward and return stroke so that reciprocating motion can be achieved, and (ii) optimize the wind power capture during the linear motion of the blade during the stroke.

Along with pitch control, a hydraulic control mechanism 9 can be used to (i) ensure that the high pressure fluid is directed to the correct side of the cylinder 8 with respect to the piston 6, and (ii) the power extracted is maximized by controlling the speed of the traveling blade.

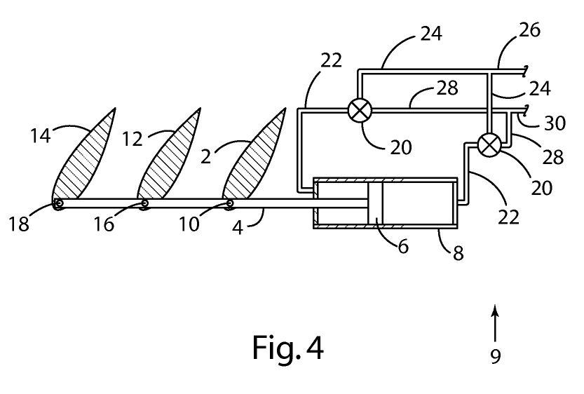

FIG. 4 shows an illustrative realization of the hydraulic control mechanism 9 used to ensure that the correct side of the double acting piston-cylinder is pressurized. The working hydraulic fluid in the cylinders 8 is connected at both ends through piping 22 to a two-way valve 20 each. The two-way valves 20 can have two other outlets 24 and 28 each. The outlets 24 connect to high pressure side 26, while the outlets 28 connect to low pressure side 30. The state of the two-way valve 20 determines whether side 22 is connected to outlet 24 or 28, i.e. which side of the cylinder 8 is connected to the pressure side. Thus, appropriate control of the state of the two two-way valves 20 can be achieved.

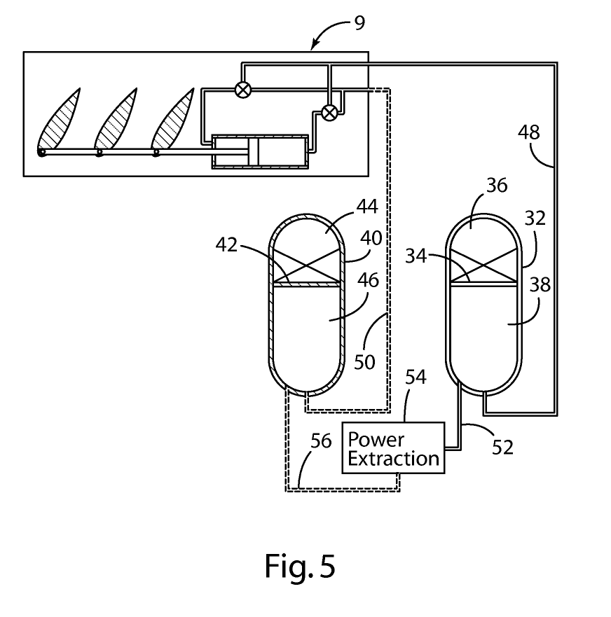

A complete traveling bland wind mill system is shown in FIG. 5. The high pressure side from the two-way valves 20 is connected through a high pressure line 48 to an accumulator 32. The accumulator 32 consists of two spaces 36 and 38 separated by a flexible diaphragm 34. Space 36 contains a compressible fluid (typically Nitrogen), and space 38 contains an incompressible fluid (typically oil).

The low pressure side 30 from the two-way valves 20 is connected through a low pressure line 50 to an accumulator 40. The accumulator 40 consists of two spaces—44 containing a compressible fluid (typically Nitrogen or air), and 46 containing the working fluid.

A separate tap 52 from the high pressure accumulator 32 can be used to drive a power extraction mechanism 54. An example of such a power extraction mechanism 54 is a hydraulic pump motor. There is a low pressure return line 56 from the power extraction mechanism 54 to the low pressure accumulator 40 so that working fluid can be recycled.

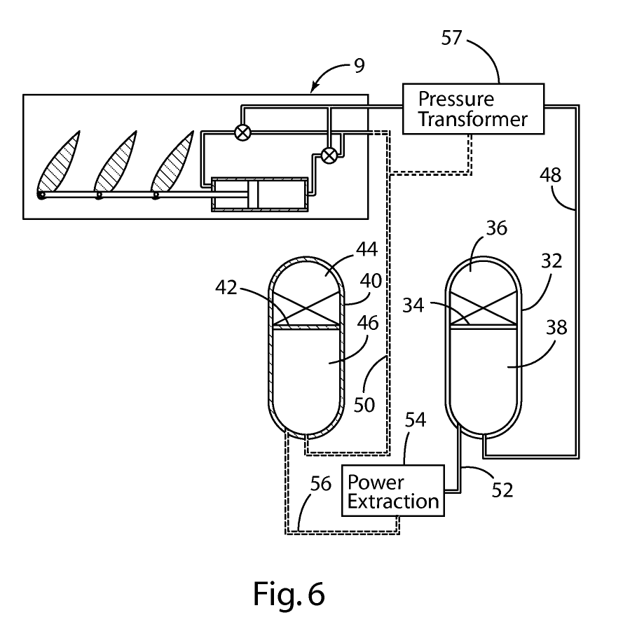

As already mentioned, the speed of the traveling blade is an important factor in the overall efficiency of power extraction. Some level of control of the blade can be provided by the pitch control. Additional finer control can be achieved by controlling the load forces on the blades from the hydraulic fluid pressure. It is proposed that this is achieved through a controllable pressure transformer 57 as shown in FIG. 6. The pressure transformer 57 can be placed in the high pressure line 48 between the blade cylinder output and the high pressure accumulator 32 as shown. A bleed line 58 can be provided back to the low pressure line 50 of the circuit.

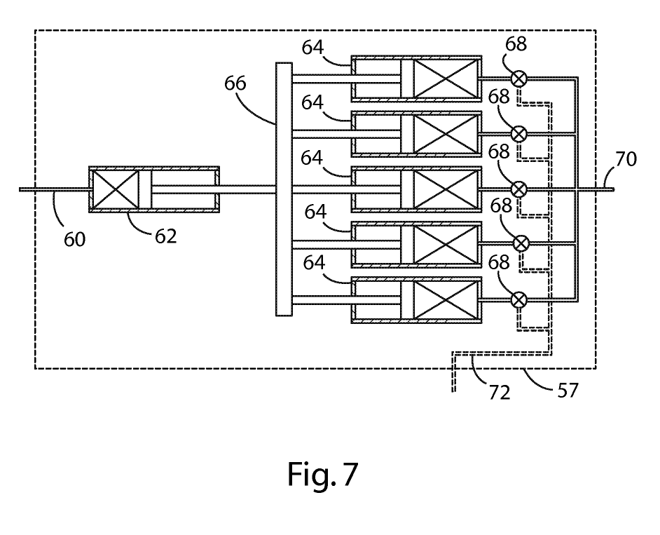

An illustrative realization of a controlled pressure transformer 57 is shown in FIG. 7. It consists of a primary piston-cylinder arrangement 62, to which the high pressure line is fed through line 60. The piston side of 62 is attached to a common shaft 66. This common shaft 66 is attached to the pistons of several secondary piston-cylinder arrangements 64. (A total of five such cylinder arrangements 64 are shown in this illustration). Each of the secondary piston cylinder arrangements 64 can be connected on the fluid side to a two-way valve 68 each. One outlet of the two-way valve 68 is connected to the high pressure line 70, while the other outlet is connected to a bleed line 72.

The pressure at the outlet (shown at 70) of the pressure transformer 57 corresponds to the high pressure accumulator pressure. The pressure at the inlet per line 60 will depend on the ratio of the piston areas, as well as the two-way valves 68 that are open. Thus, controlling the state of the two-way valves 68 will provide control on the load pressure at line 60 that is eventually felt by the blades, and thereby affects control on the blade speed.

The number of such cylinders and the area of the pistons in the different cylinders will define the resolution of the control achievable, and this will be a design trade-off against cost and complexity of the pressure transformer 57.

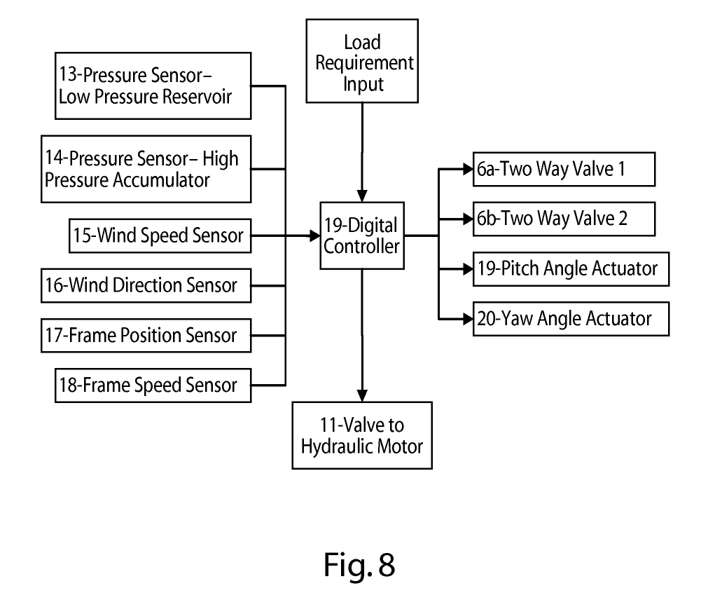

The control of the various two-way valves and the pitch of the blades is a complex task that should be performed by a computer. The inputs and outputs for the logic that can be used are shown in the control diagram of FIG. 8. A load requirement can be input into a digital controller 19. Specific input can be entered, such as pressure sensor—low pressure reservoir 13, pressure sensor—high pressure accumulator 14, wind speed sensor 15, wind direction sensor 16, frame position sensor 17 and frame speed sensor 18. Output may include a valve to a hydraulic motor 11. Specific output can be produced, such as two-way valves, i.e. 6a and 6b for valves, pitch angle actuator 19 and yaw angle actuator 20. The digital controller 19 can sense motion of the aerofoil blades, pressures in the hydraulic system, wind parameters, the speed of the aerofoil blade, and power output from the hydraulic system, and can control orientation of the aerofoil blades with respect to wind.

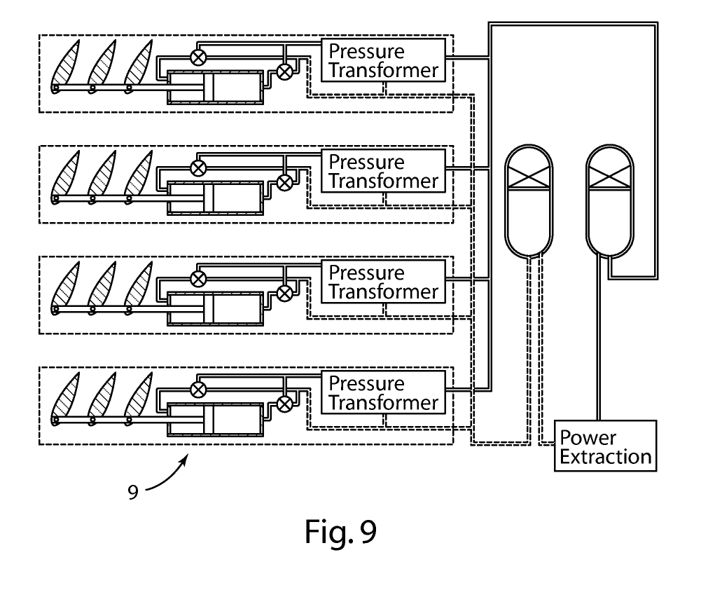

These concepts can clearly be extended to a large wind farm as illustrated in FIG. 9 with multiple linear wind turbines combined in a wind farm adapted for power extraction.

### Construction:

The fundamental concept of the wind harnessing device discussed above can be realized in many ways. Some of the construction concepts for these are highlighted.

### Aerofoil Layout

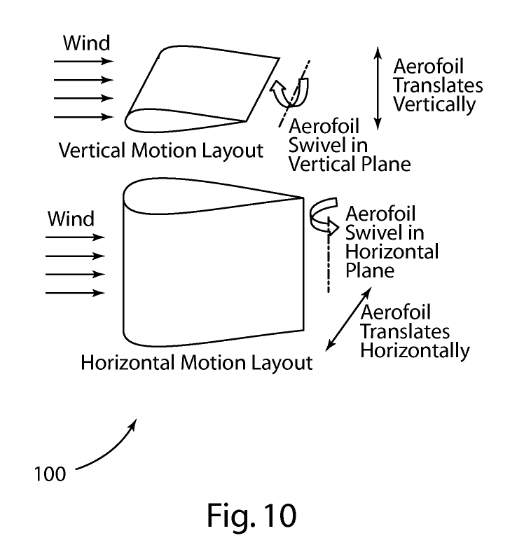

The aerofoil 2 can be laid out in many ways. Two potential ways are shown in FIG. 10. The vertical layout has the advantage of minimizing the ground footprint. The horizontal layout has the advantage of gravity-independent operation. The actual realization will be based on the business trade-offs required for the specific application of the concept. In this disclosure, without loss of generality, the concepts using a vertical or horizontal layout are illustrated.

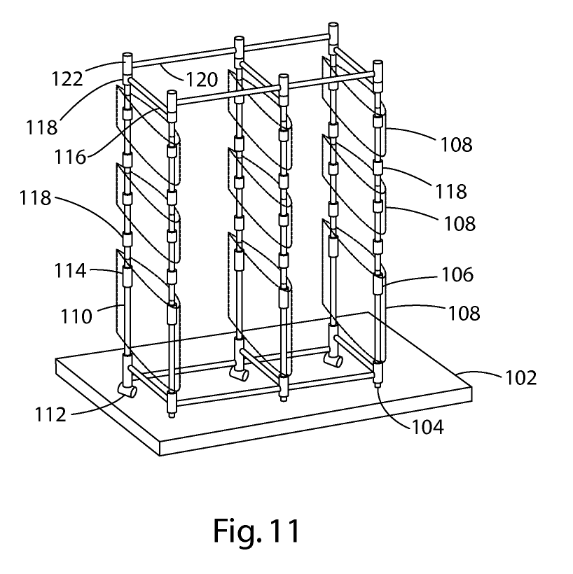

A critical consideration to increase the efficiency of power extraction is the use of multiple blades moving synchronously. FIG. 11 illustrates how such a realization can be achieved with a three-blade system as an example of a multiple blade linear wind turbine platform. Other number of blades can be constructed in a similar fashion. The entire system is mounted on a platform 102. This is a moving platform, moving in a reciprocating fashion. Therefore, such platforms could be built on rails, which are not shown in the figure. The platform 102 can be a solid platform—however, this is just one rendering. In practice, design optimization will be done on the platform 102 and a minimal weight platform with appropriate strength needs to be used.

On the platform 102, masts 104 correspond to the sets of blades desired. These masts 104 are rigidly attached to the platform 102. These masts 104 need not be of a single-piece construction. A simple method would be to concatenate multiple cylindrical shafts or pipes through joints 106. This enables easy transportation of the materials to the deployment site, and the wind mill is erected on-site.

The mast 104 carries one or more sections 100 of the blade 108. These individual sections 100 can be a symmetrical aerofoil shape. These sections can rotate about the mast axis. They need not be the same height each. The sizes can be configured based on the trade-off between desired flexibility in achieving overall blade heights, and ease of manufacture and transportation. A particularly important point to note is that per the disclosure, no forces are transmitted between the different segments of the blade. Therefore, the blade sections 100 need to be designed only for the lift and drag forces. This is unlike the case of rotary fan blades, where they need to support the weight and centrifugal forces of the rest of the blade away from the center. A significant consequence of this is that the entire blade can be made in small sections 100. This can prove to be a critical advantage in manufacturing, transportation, assembly and repair.

The blades can be supported by a second shaft 110, which passes through the trailing edge of the blade sections as shown in FIG. 11. The second shaft 110 can also be constructed from multiple sections of shafts or pipes using joints 114. The second shaft 110 is not rigidly fixed to the platform 102; instead it is free to move, such as on rollers 112, in a circular arc around the mast.

The blade sections are connected to each other through connecting rods 120, which are attached through revolute joints 122 to the second shafts 110 of the blade sections as shown. Similar rods can be attached to the mast shaft also for added stability. Multiple sets of connecting rods 120 could be used to provide appropriate strength. In FIG. 11, two sets are shown: one at the bottom and one at the top. These connecting rods 120 ensure synchronous motion of the blade sections.

Pitch control actuation can be now achieved by either controlling the motion of the connecting rods 120, or the second masts 110, or by controlling the inclination of the blades around the axis of the mast 104.

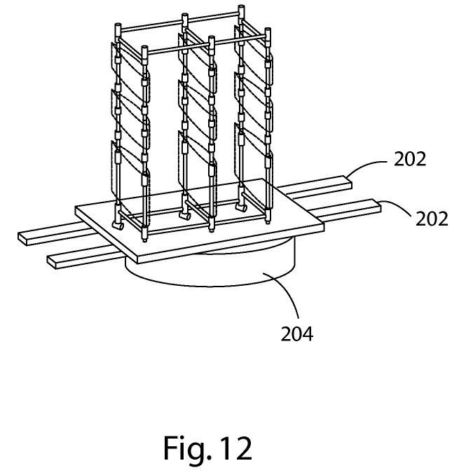

FIG. 12 shows a three-blade linear wind turbine platform that can be on rails for yaw control. The platform 102 on rails 202, which is itself attached to a rotating disk 204. Disk 204 is capable of rotating about vertical axis. Disk 204 can be rotated so that each aerofoil 2 is directed into the wind at the appropriate angle, which is called yaw control.

The hydraulic compression mechanism can also be located in the disk 204.

### Operation:

The operation of the disclosed device is captured by these various control tasks below:

Yaw Control: The blades are oriented such that they “face” the wind to increase energy production. In one embodiment disclosed, disk 204 will be rotated to achieve this. In turn, this will orient the platform 102.

Pitch Control: The blades' orientation is further finely adjusted such that optimal power extraction is facilitated. This control could be realized in many ways. In one embodiment, the second shaft 110 can be hydraulically achieved to achieve pitch control.

Blade Velocity Control: The velocity of the blades in the linear direction can be controlled additionally by controlling the load pressure on the hydraulic pressure transformer 57, as well as the two-way valves 20. The load pressure on the hydraulic pressure transformer is controlled by controlling the state of the two-way valves 68.

The advantages of the present device include, without limitation,

Built-in storage system for energy, which can be supplied on demand

Simple construction and easy to maintain

Blades can be manufactured in parts and assembled at site

Modular—additional aerofoil blades can be added to an unit or multiple units added to achieve desired capacity

No gear box necessary

Multiple wind mills can be connected to one set of reservoirs, reducing cost

For electricity generation, the generator can be at ground level

For electricity generation, a synchronous generator can be used since the hydraulic motor can be made to run at a constant speed

If mechanical power can be directly utilized from the hydraulic accumulators, then there is no need for electric generators. This is typically useful when the end use happens near the location of the hydraulic accumulators

The hydraulic system need not be a “closed system.” An excellent example of an open hydraulic system is that based on water. In particular, a hydro-electric power station might be a perfect candidate for use of the device to “pump” water from the downstream side of the dam to the upstream side of the dam. This would be the same as the idea of “pumped storage” that is currently used in hydro-electric power systems, but instead of using electric power it would use wind power.

Other benefits include:
1. Very High Efficiency Power Conversion
   i. Electricity Generation—38.8% across entire speed range for wind
   ii. Mechanical Power Generation—40% across entire speed range for wind
2. Very Low Cost (relative to current wind power technologies)
   i. Leverages existing technologies: Trusses, hydraulics (mostly low speed hydrostatics), valves, accumulators
3. Very low O & M costs—especially important for off-shore farms
   i. Accumulators can be built-up on-shore
   ii. Alternatively, deep see accumulators can take advantage of high pressures available
4. Built-in energy storage implies optimal delivery of power to grid
5. Mechanical power conversion can be used as an alternative power source
   i. Especially useful in developing economies
6. Very easy adaptation to pump water to water tanks
   i. Especially useful in developing economies
7. Low speeds imply very low noise pollution
8. Technology is readily scalable to larger or lower power ratings

While the foregoing written description enables one of ordinary skill to make and use what is considered presently to be the best mode thereof, those of ordinary skill will understand and appreciate the existence of variations, combinations, and equivalents of the specific embodiments, methods, and examples herein. The invention should therefore not be limited by the described embodiments, methods, and examples, but by all embodiments and methods within the scope and spirit of the invention as claimed.

What is claimed is:

1. A device for harnessing wind power using linear motion, the device comprising:
reciprocating aerofoil blades that translate linearly converting wind energy into pressurized hydraulic working fluid that can be used for generating electrical energy or producing mechanical power;
a reciprocating piston and hydraulic cylinder arrangement; and
a hydraulic high pressure accumulator that stores hydraulic energy from the hydraulic working liquid being pushed into the high pressure accumulator,
wherein the aerofoil blades drive the piston to build up hydraulic pressure in the accumulator through the piston and hydraulic cylinder arrangement.

2. The device of claim 1 wherein the aerofoil blades translate linearly along rigid guided rails or supporting columns.

3. The device of claim 1 further comprising a digital controller that senses motion of the aerofoil blades, pressures in the hydraulic system, wind parameters, the speed of the aerofoil blade, and power output from the hydraulic system, and controls orientation of the aerofoil blades with respect to wind.

4. The device of claim 1 wherein the aerofoil blades are pivotably connected to a linkage that directly drives the reciprocating piston inside the hydraulic cylinder.

5. The device of claim 1 further comprising a hydraulic control mechanism to ensure that the pressurized hydraulic working fluid is directed to a correct side of the hydraulic cylinder with respect to the piston, the hydraulic control mechanism includes two-way valves with one set of outlets connected to a low pressure side and another set of outlets connected to the high pressure side to ensure pressurized hydraulic working fluid is pushed in the accumulator.

6. The device of claim 5 further comprising a pressure transformer in the high pressure line adjacent to the accumulator.

7. The device of claim 4 having a plurality of parallel reciprocating aerofoil blades that move in synchronization, wherein the linkage is a common connecting rod.

8. The device of claim 7 wherein the plurality of parallel reciprocating aerofoil blades are built on a reciprocating platform and a mast attached to the platform wherein the aerofoil blades can rotate around the mast.

9. The device of claim 8 wherein the aerofoil blades are supported by a second shaft that passes through a trailing edge of the aerofoil blades to ensure synchronous motion of the aerofoil blades, the second shaft is not rigidly fixed to the platform but is free to move in a circular arc around the mast.

10. The device of claim 8 wherein the platform is attached on a rotating disk that is capable of rotating about a vertical axis, wherein the disk can be rotated so that the aerofoil blades are oriented into the wind at an appropriate angle for yaw control.

11. A device for harnessing wind power using linear motion, the device comprising:
a plurality of parallel reciprocating aerofoil blades that translate linearly in synchronization, converting wind energy into pressurized hydraulic working fluid that can be used for generating electrical energy or producing mechanical power;
a reciprocating piston and hydraulic cylinder arrangement; wherein the aerofoil blades are pivotably connected to a linkage that drives the reciprocating piston inside the hydraulic cylinder;
a hydraulic high pressure accumulator that stores hydraulic energy from the pressurized hydraulic working liquid being pushed into the high pressure accumulator; and
a hydraulic control mechanism to ensure that the pressurized hydraulic working fluid is directed to a correct side of the hydraulic cylinder with respect to the piston; and a hydraulic low pressure accumulator that provides the working fluid to be pressurized.

12. The device of claim 11 wherein the plurality of parallel reciprocating aerofoil blades are built on a reciprocating platform and a mast attached to the platform wherein the aerofoil blades can rotate around the mast.

13. The device of claim 12 wherein the aerofoil blades are supported by a second shaft that passes through a trailing edge of the aerofoil blades to ensure synchronous motion of the aerofoil blades, the second shaft is not rigidly fixed to the platform but is free to move in a circular arc around the mast.

14. The device of claim 12 wherein the platform is attached on a rotating disk that is capable of rotating about a vertical axis, wherein the disk can be rotated so that the aerofoil blades are oriented into the wind at an appropriate angle for yaw control.
